(19) United States
(12) Patent Application Publication
(10) Pub. No.: US 2006/0201560 A1
(43) Pub. Date: Sep. 14, 2006

(54) Time -adjustable deflecting valve with momentary closure

(76) Inventors: Carlos Felix Duran, Chihuahua (MX); Rodrigo Frias Orozco, Chihuahua (MX); Luis Felix Duran, Chihuahua (MX)

Correspondence Address: Luis Felix, 2947 S Cucamonga Avenue, Ontario, CA, 91761, US

(21) Appl. No.: 10/544,409

(22) PCT Filed: Feb. 9, 2004
(86) PCT No.: PCT/MX04/00005

§ 371 Date: Dec. 8, 2005

(30) Foreign Application Priority Data
Feb. 7, 2003 (MX) PA/A/2003/001211

(51) Int. Cl. F16K 11/07

(52) U.S. Cl. 137/625.48

(57) ABSTRACT

The invention relates to a valve which enables the user mechanically to recover the cold water contained in shower tubes, which is usually wasted through general drainage, for the subsequent use thereof. The inventive valve can also be used to reduce water wastage during daily bathing. The purpose of the invention is to provide a type of valve which helps save water in an easy-to-use manner, without limiting same to other possible applications.

### DESCRIPTION OF THE INVENTION

All the details pertaining to this new design are clearly described in the following document.

Attached to the document you will also find three figures.

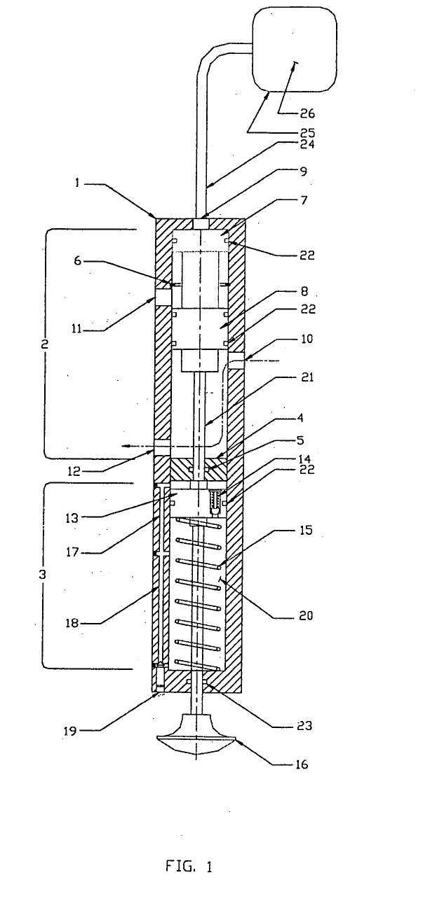

FIG. 1 is a cross section of the valve, which shows all of the components. The main body of this valve contains two Chambers: The Upper Chamber (2) and the Lower Chamber (3).

Both Chambers are contiguous and separated by an intermediate wall (4). Such wall also houses a rod Seal (5).

The Upper Chamber contains a Retaining Ring (6), a Momentary Closure Piston (7), and a Water Flow Deflecting Spool (8).

In addition, the Upper Chamber has four ports: The Maintained Closure Port (9), the Inlet Main Port (10), the Recuperation Outlet Port (11), and the Shower Port (12).

The Lower Chamber (3) contains: a Time Spool (13), the spool contains a unidirectional valve (check valve) (14). Fluid (20) passes only when fluid pressure at the bottom of the time spool (13) is greater than the fluid pressure at the top of the time spool (13).

The Check Valve (14) prevents fluid to flow in reverse conditions.

There is a Compression Spring (15) under the Time Spool (13).

The time spool assembly is completed by a manual actuator (16).

The side wall of the Lower Chamber (3) has two Channels: the Fast Stroke Channel (17), with its stroke (28), and the Slow Stroke Channel (18), with its stroke (27).

The lower wall of the Lower Chamber (3) contains a Needle Valve (19).

The Needle Valve (19) adjusts the flow of the Captive Flow (20).

An Interconnecting Rod (21) connects the Water Flow diverting spool (8) and the Time Spool (13).

Pistons seals (22) and rod seals (23) complement the assembly.

FIG. 1 shows the Momentary Closure Piston (7), the Flow Diverting Spool (8), and the Time Spool (13) at their initial position.

Under this condition, water entering through the Main Inlet Port (10) will exit through the Shower Port (12) to allow having cold water in the shower under this selection.

The procedure to select hot water, and the saving of the cold water stored within the interconnecting piping that runs from water heater to shower, is as follows:

a) Pull Manual Actuator (16) down.

b) Open Conventional Shower Hot Water Valve.

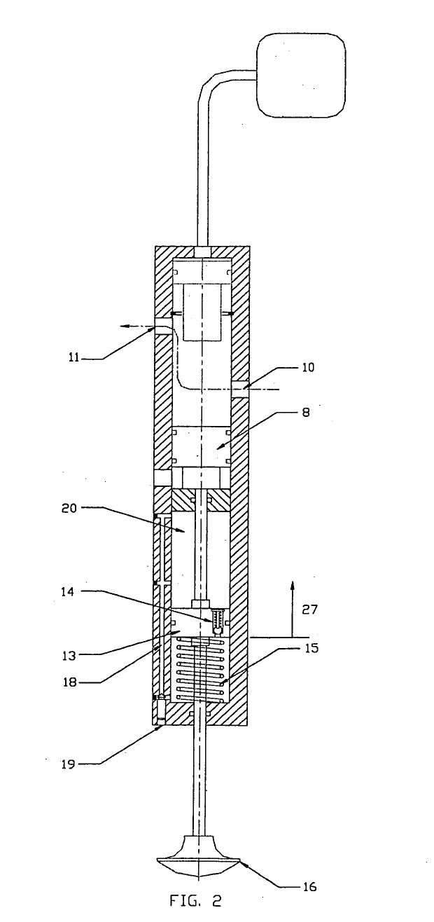

FIG. 2 shows that, by pulling Manual Actuator (16) down, the Time Spool (13) and the Water Flow Diverting Spool (8) are also brought down at the same time.

This action allows the cold water, which is contained within the pipe, to flow from the Main Inlet Port (10) through the Recuperation Outlet Port (11).

The Recuperation Outlet Port (11) would be plumbed directly to a water Recuperator.

c.) The downward displacement of the Manual Actuator (16), makes the Time Spool (13) to move down and displace the fluid (20) contained below the Spool; then, the Fluid (20) flows upward through the Check Valve (14).

Under the previously mentioned condition, the Spring (15) is compressed. Once the Manual Actuator (16) is released, the stored energy within the Spring (15) will exert pressure on the Fluid (20), now contained above the Time Spool (13).

d.) The Fluid (20) is now forced to go downward and through the Slow Stroke Channel (18). The transportation of Fluid towards the Lower Chamber occurs during the displacement (27) of the Time Spool (13). The travel time of the Time Spool (13) is controlled by the adjustment of the Needle Valve (19), which adjusts the flow trough channel (18). The regulation of this flow, regulates the travel speed of the Water Flow Deflecting Spool (8) and the Time Spool (13). The time adjustment is determined according to installation needs between the water heater and the shower.

e.) During the elapsed time that the Deflecting Spool (8) and the Time Spool (13) reach their original position, the Cold Water within the pipe is contained in the Water Recuperator.

f.) At the end of this cycle, the water entering thru the Main Inlet Port (10) will be flowing to the shower through Shower Port (12). At this point, hot water is expected to run thru shower.

g.) At this time, the Conventional Shower Cold Water Valve is opened to blend the hot water and the cold water and thus maintain the desired temperature.

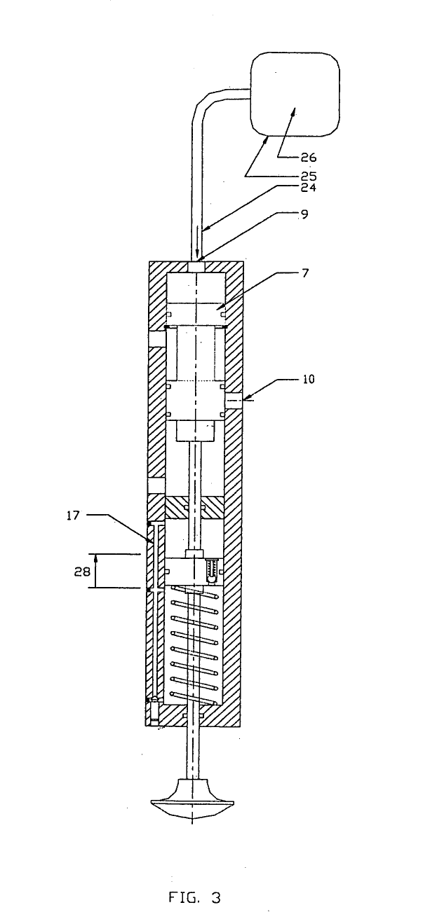

h.) Furthermore, water is saved when the Momentary Closure Piston (7) is activated, as shown in FIG. 3. Pressure exerted by the person's body weight, during the normal shower, over the fluid filled Cushion (25) which contains the Fluid (26).

The fluid runs through the interconnecting line (24) that connects the Cushion (25) and the Maintained Close Port (9). The Inlet Main Port (10) is closed when the Momentary Closure Piston (7) is displaced; this displacement occurs temporarily, while the person taking the shower steps on the Cushion (25). The return action must occur in a quick manner due to the open Channel (I 7) and its non-regulated displacement (28).

i.) t the end of the shower, both conventional valves, hot and cold water, are turned off.

j.) At the beginning of another shower, the person must activate the Manual Actuator (16) once again.

Having already sufficiently described our invention, we consider it to be a novelty and, therefore, claim the content in the following clauses as our exclusive property:

1. Two chambers are integrated in a cylindrical-shaped body: The Lower Chamber (3) and the Upper Chamber (2). The Lower Chamber contains the Time Spool (13); with a Check Valve (14) and an hermetic Seal (22) in its body. The Interconnecting Rod (21) extends to the Upper Chamber (2), through its Intermediate Wall (4) by means of a Rod Seal (5), which constitutes the Actuator. The other extreme of the Interconnecting Rod (21) continues to the Upper Chamber (2), passing through the wall that separates both chambers by means of a Seal (22), thus forming a Common Body. A Spring (15) situated on the lower part of the Time Spool (13), concentric to the Interconnecting Rod and sitting in the interior side of the bottom wall, serves to reposition the Time Spool (13). In the vertical wall of the chamber exist two channels in series: the Fast Stroke Channel (17) and the Slow Stroke Channel (18). This is where a Needle Valve (19) is situated, which serves to previously adjust the amount of flow from a captive fluid, and in turn regulates the repositioning time of the Valve. The Upper Chamber contains the Deflecting Spool (8) , the Seals (22), and the Momentary Closure Piston (7). The following four ports are distributed on the body: Main Inlet Port (10), the Recuperation Outlet Port (11), the Shower Port (12), and the Momentary Closure Port (9). The Momentary Closure Port is itself a control port. The control port communicates with a Cushion (25) that contains Fluid (26) by means of an Interconnect Line (24).

2. Improvements made to shower valve; as it was amended in the previous item 1. The Time-Adjustable Deflecting Valve with Momentary Closure, has in its Lower Chamber: the Time Spool (13) which is characterized by the Fast Stroke Channel (17) and the Low Stroke Channel (18). The Upper Chamber (2) contains the Momentary Closure Piston (7). Thus these components allow that the Water Flow Diverting Spool (8) controls the flow of water between the Main Inlet Port (10), the Recuperation Outlet Port (11) and the Shower Port (12). The Valve re-positioning time is controlled by adjustment and by the Actuator. The temporary closure if the Valve is achieved by pressing the Cushion (25).
